(19) United States
(12) Patent Application Publication
(10) Pub. No.: US 2010/0181000 A1
(43) Pub. Date: Jul. 22, 2010

(54) PNEUMATIC TIRE AND METHOD FOR MANUFACTURING THE SAME

(75) Inventor: Yasuhiro TAKAHASHI, Hiratsuka-shi (JP)

Correspondence Address: HAMRE, SCHUMANN, MUELLER & LARSON, P.C., P.O. BOX 2902, MINNEAPOLIS, MN, 55402-0902, US

(73) Assignee: THE YOKOHAMA RUBBER CO., LTD., Tokyo (JP)

(21) Appl. No.: 12/613,375

(22) Filed: Nov. 5, 2009

(30) Foreign Application Priority Data
Jan. 20, 2009 (JP) 2009-010092

(51) Int. Cl. B60C 9/02; B29D 30/16

(52) U.S. Cl. 152/532; 156/134

(57) ABSTRACT

A pneumatic tire includes: a carcass; an inner liner disposed at an inner side of the carcass in a tire radial direction; and a tie rubber layer disposed between the carcass and the inner liner, wherein the inner liner and the tie rubber layer are layered with the ends thereof being shifted from each other in a tire circumferential direction, and wherein the inner liner and the tie rubber layer are spliced with the ends of the inner liner in the tire circumferential direction overlapping each other and with the ends of the tie rubber in the tire circumferential direction overlapping each other.

### CROSS-REFERENCE TO THE RELATED APPLICATION(S)

The present disclosure relates to the subject matters contained in Japanese Patent Application No. 2009-010092 filed on Jan. 20, 2009, which are incorporated herein by reference in its entirety.

### FIELD

The present invention relates to a pneumatic tire and a method for manufacturing the pneumatic tire, which is used for vehicles such as cars, trucks, and buses.

### BACKGROUND

Conventional pneumatic tire is provided with a carcass formed over a pair of bead portions disposed along the tire width direction and an inner liner disposed inside along the tire radial direction of the carcass. A tie rubber is generally disposed between the inner liner and the carcass for preventing peeling. Generally, the inner liner is made of rubber mainly including butyl rubber and having low gas permeability, and the tie rubber is made of the same kind of rubber as the carcass.

When manufacturing such a pneumatic tire, an inner liner and tie rubber layered in advance are wound around a forming drum so as to splice ends thereof along the tire circumferential direction to each other. In this splice portion, the outer face of the inner liner and the inner face of the tie rubber alone are in contact with each other, and hence, different types of rubber are bonded to each other. Therefore, when the tire are repeatedly deformed while running, peeling is caused in the splice portion due to the difference in the rubber properties, so as to disadvantageously cause a crack.

As a known countermeasure against this disadvantage, ends along the tire circumferential direction of a sheet obtained by layering an inner liner and tie rubber are cut to be inclined against the thickness direction, so that a first end along the tire circumferential direction of the inner liner disposed to have an acute inclined face can be in contact with the inner face of a second end along the tire circumferential direction of the inner liner and that a second end along the tire circumferential direction of the tie rubber disposed to have an acute inclined face can be in contact with the outer face of a first end along the tire circumferential direction of the tie rubber. Thus, the inner liner and the tie rubber are continuously spliced along the tire circumferential direction. An example of such technique is disclosed in JP-A-11-005261.

When the sheet obtained by layering the inner liner and the tie rubber is cut to have inclined ends along the tire circumferential direction as in the conventional technique, however, the length of the inclined faces overlapping in the splice portion is not sufficient, and therefore, in order to improve the effect to prevent the occurrence of a crack, it is necessary to further improve the bond strength between the ends of the inner liner and between the ends of the tie rubber.

### SUMMARY

One of objects of the present invention is to provide a pneumatic tire and a method for manufacturing the same in which the bond strength between ends of an inner liner and between the ends of tie rubber in a splice portion are improved.

According to an aspect of the invention, there is provided a pneumatic tire including: a carcass; an inner liner disposed at an inner side of the carcass in a tire radial direction; and a tie rubber layer disposed between the carcass and the inner liner, wherein the inner liner and the tie rubber layer are layered with the ends thereof being shifted from each other in a tire circumferential direction, and wherein the inner liner and the tie rubber layer are spliced with the ends of the inner liner in the tire circumferential direction overlapping each other and with the ends of the tie rubber in the tire circumferential direction overlapping each other.

According to another aspect of the invention, there is provided a method for manufacturing a pneumatic tire including: a carcass; an inner liner disposed at an inner side of the carcass in a tire radial direction; and a tie rubber layer disposed between the carcass and the inner liner, wherein the method includes: layering the inner liner and the tie rubber layer with the ends thereof being shifted from each other in a tire circumferential direction to form a layered sheet; winding the layered sheet around a forming drum; and splicing the inner liner and the tie rubber layer with the ends of the inner liner in the tire circumferential direction overlapping each other and with the ends of the tie rubber in the tire circumferential direction overlapping each other.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a partial front cross-sectional view of a pneumatic tire according to an embodiment of the invention.

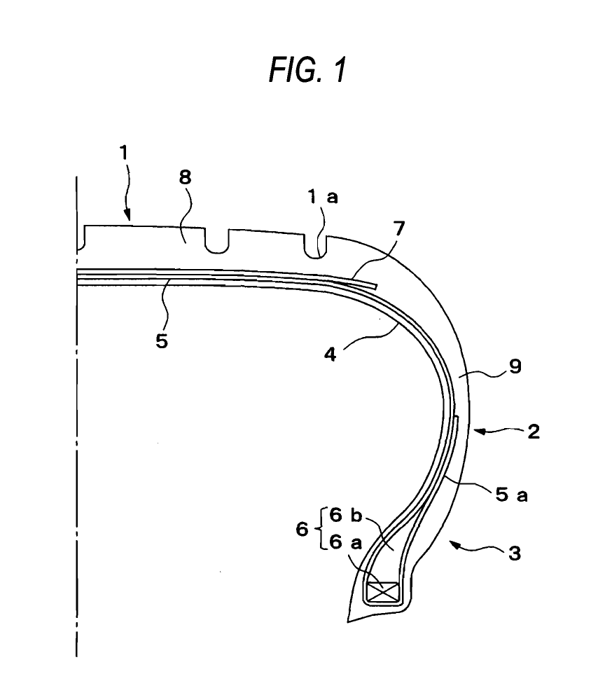

FIG. 2 is a schematic diagram of a part of a tire fabrication process.

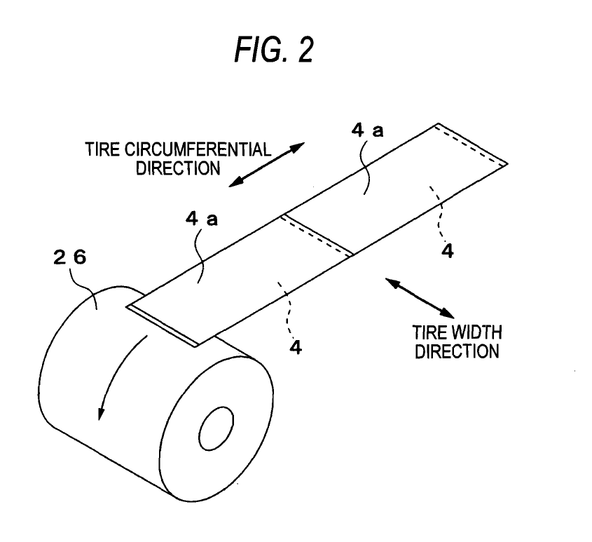

FIGS. 3A, 3B and 3C are side views of an inner liner and tie rubber.

FIGS. 4A and 4B are side views of a splice portion of the inner liner and the tie rubber.

FIG. 5 is a side view illustrating a step of rolling and layering an inner liner and tie rubber.

FIG. 6 is a front view of a roller die.

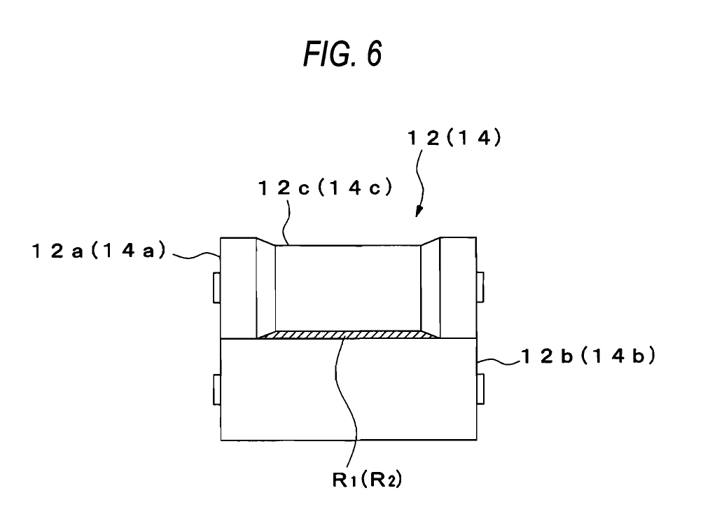

FIG. 7 is a plan view illustrating a procedure in a step of cutting and shaping an inner liner and tie rubber.

FIG. 8 is a plan view illustrating another procedure in the step of cutting and shaping the inner liner and the tie rubber.

FIG. 9 is a plan view illustrating another procedure in the step of cutting and shaping the inner liner and the tie rubber.

FIG. 10 is a plan view illustrating another procedure in the step of cutting and shaping the inner liner and the tie rubber.

FIG. 11 is a plan view illustrating another procedure in the step of cutting and shaping the inner liner and the tie rubber.

FIG. 12 is a plan view illustrating another procedure in the step of cutting and shaping the inner liner and the tie rubber.

FIG. 13 is a plan view illustrating another procedure in the step of cutting and shaping the inner liner and the tie rubber.

FIG. 14 is a plan view illustrating another procedure in the step of cutting and shaping the inner liner and the tie rubber.

FIG. 15 is a plan view illustrating another procedure in the step of cutting and shaping the inner liner and the tie rubber.

FIG. 16 is a plan view illustrating another procedure in the step of cutting and shaping the inner liner and the tie rubber.

FIG. 17 is a plan view illustrating another procedure in the step of cutting and shaping the inner liner and the tie rubber.

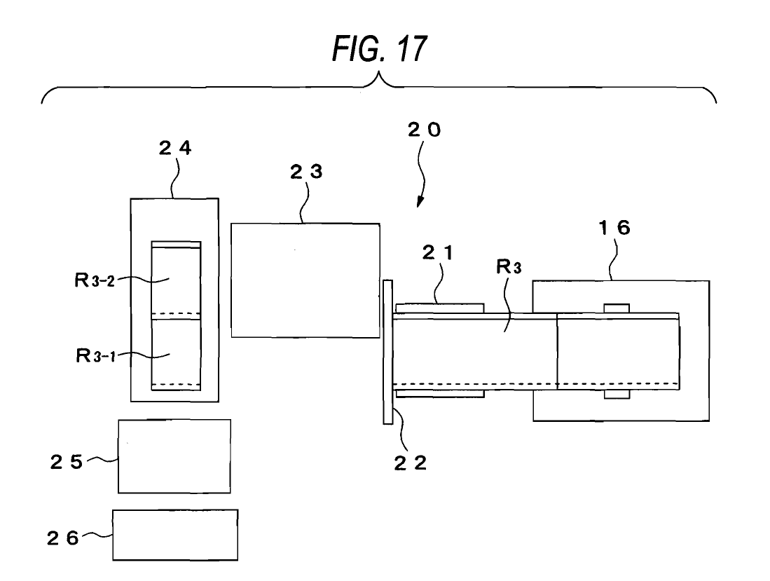

FIG. 18 is a plan view illustrating another procedure in the step of cutting and shaping the inner liner and the tie rubber.

FIG. 19 is a plan view illustrating another procedure in the step of cutting and shaping the inner liner and the tie rubber.

FIG. 20 is a diagram of results of a test.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted.

The pneumatic tire according to the embodiment of the present invention includes a tread portion 1 formed on the side of the outer circumference of the tire, a pair of sidewall portions 2 formed on the both sides along the width direction of the tire, and a pair of bead portions 3 formed on the both sides along the width direction of the tire. Also, the pneumatic tire includes an inner liner 4 disposed on the inner side of the tire, a carcass member 5 disposed outside the inner liner 4, a pair of bead members 6 disposed on the both sides along the width direction of the tire, a belt 7 disposed outside the carcass member 5, a tread member 8 disposed on the side of the outer circumference of the tire, and a pair of sidewall members 9 disposed on the both sides of the tire.

The inner liner 4 is made of a rubber sheet with low gas permeability mainly including butyl rubber, and is disposed on the side of the inner circumference of the carcass member 5. The inner liner 4 is adhered to the inner circumference of the carcass member 5 with tie rubber (tie rubber layer) 4a, which is made of rubber equivalent to that used for the carcass member 5, sandwiched therebetween. Ends along the tire circumferential direction of the inner liner 4 and the tie rubber 4a are formed respectively as inclined faces A1 and A2 inclined against the tire radial direction, and each of the inclined faces A1 and A2 is formed to have an inclination angle θ not less than 10 degrees and not more than 50 degrees against a direction perpendicular to the tire radial direction.

The carcass member 5 is made of a rubber sheet in which a plurality of carcass cords 5a are arranged along the tire circumferential direction, and the both ends thereof along the width direction are folded toward the sidewall portion from the inside to the outside along the tire width direction so as to enfold the bead member.

The bead member 6 includes a bead core 6a including a bundle of wires such as metal wires and a bead filler 6b made of rubber with a substantially triangle cross-section, and the bead filler 6b is disposed outside the bead core 6a.

The belt 7 is obtained by coating a belt cord made of a steel, high strength fiber or the like with a rubber sheet, and is disposed on the side of the outer circumference of the carcass member 5.

The tread member 8 is made of rubber formed by extrusion molding, is disposed so as to cover a center portion along the width direction of the carcass member 5 and the outer circumference of the belt 7, and has, on its outer circumference, grooves 1a as a tread pattern formed during vulcanizing molding.

The sidewall member 9 is made of rubber formed by the extrusion molding and is disposed so as to cover the both sides along the tire width direction of the carcass member 5.

Next, a method for manufacturing a pneumatic tire of this embodiment will be described. Incidentally, steps described below are merely a part of a fabrication process for the pneumatic tire and the other steps are omitted. The steps omitted from the following description may be performed by applying a conventional technique.

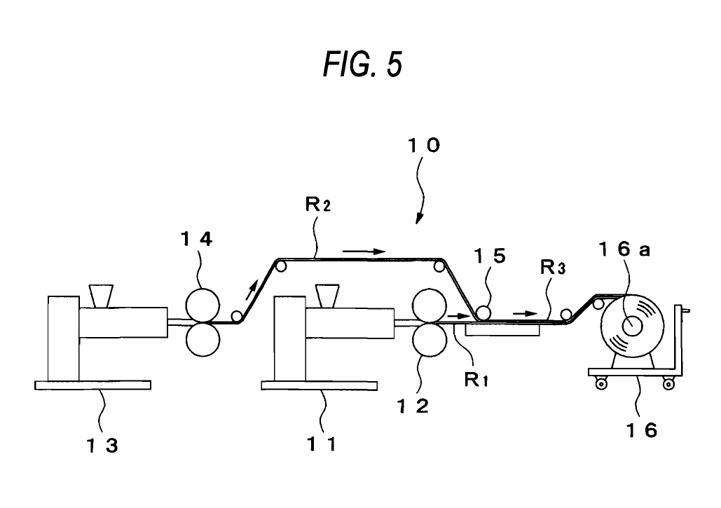

In a first manufacturing apparatus 10 for performing a step of rolling and layering an inner liner and tie rubber, as illustrated in FIG. 5, rubber extruded from a first extruder 11 is rolled with a first roller die 12 so as to form a first rubber sheet R1 to be used as the inner liner, and rubber extruded from a second extruder 13 is rolled with a second roller die 14 so as to form a second rubber sheet R2 to be used as the tie rubber.

The first roller die 12 includes a pair of rollers 12a and 12b vertically arranged, and the upper roller 12a has, on its outer circumference, a recess 12c for forming the first rubber sheet R1 into a given thickness. The both ends along the width direction of the recess 12c are tapered, so as to form the inclined faces A1 of the inner liner 4. The second roller die 14 includes a pair of rollers 14a and 14b vertically arranged, and the upper roller 14a has a recess 14c for forming the second rubber sheet R2.

The first rubber sheet R1 and the second rubber sheet R2 respectively formed by the roller dies 12 and 14 are layered in the thickness direction and are bonded to each other with pressure by a pressure roller 15. The second extruder 13 and the second roller die 14 are disposed behind the first extruder 11 and the first roller die 12, so that the second rubber sheet R2 fed from the second roller die 14 can be conveyed above the first extruder 11 and the first roller 12, and thus, the second rubber sheet R2 is placed over the first rubber sheet R1 fed from the first roller die 12.

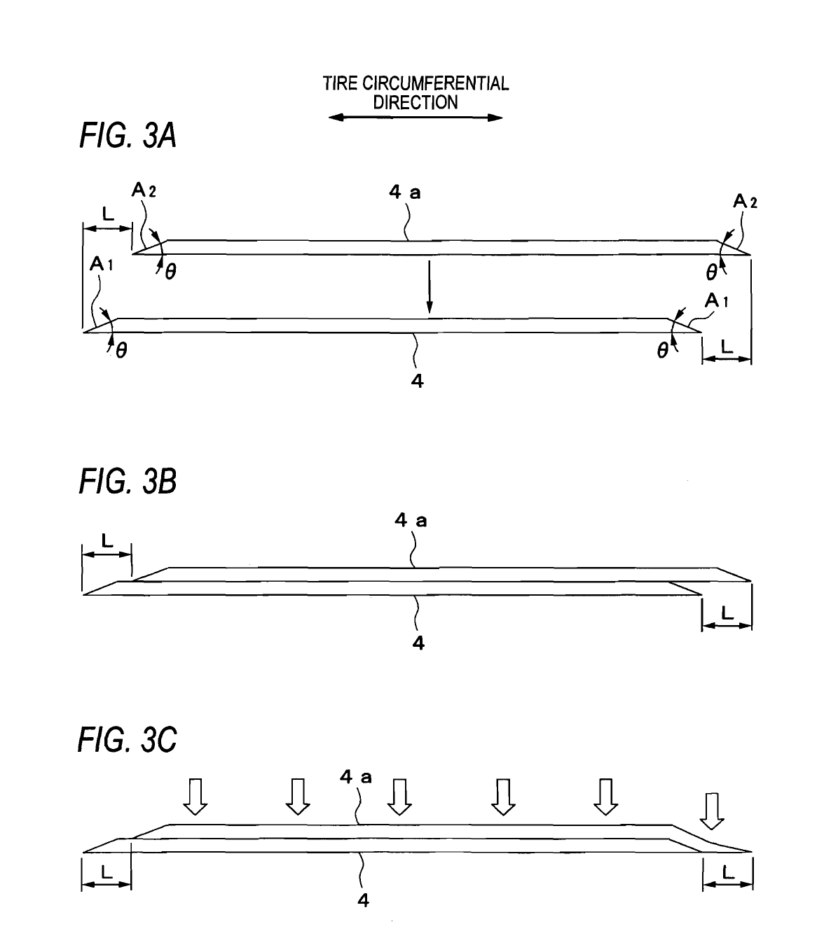

At this point, in layering the rubber sheets R1 and R2, they are shifted from each other along the width direction (corresponding to the tire circumferential direction) by a given length L (of, for example, not less than 12 mm and not more than 24 mm) as illustrated in FIGS. 3A and 3B and are bonded to each other with pressure as illustrated in FIG. 3C. As a result, a layered sheet R3 in which the first rubber sheet R1 (corresponding to the inner liner) protrudes beyond the second rubber sheet R2 (corresponding to the tie rubber) by the length L at one end along the width direction and the second rubber sheet R2 (corresponding to the tie rubber) protrudes beyond the first rubber sheet R1 (corresponding to the inner liner) by the length L at the other end along the width direction is obtained. The thus obtained layered sheet R3 is wound around a drum 16a of a carriage 16, so as to be conveyed to a second manufacturing apparatus 20 used for the following step.

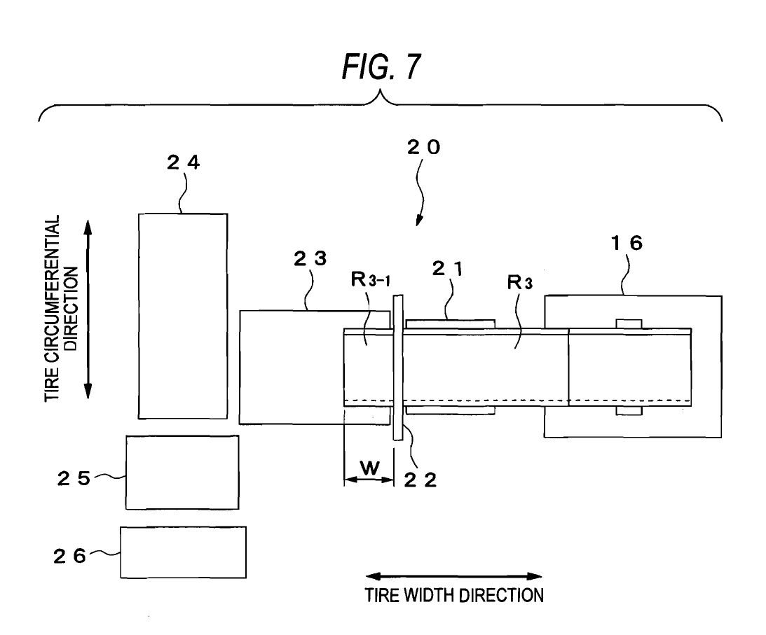

Next, in the second manufacturing apparatus 20 for performing a step of cutting and forming the inner liner and the tie rubber, as illustrated in FIG. 7, the layered sheet R3 drawn out from the drum 16a of the carriage 16 is carried by a first conveyor 21 in a lengthwise direction (toward a first side along the tire width direction) and is cut with a cutter 22 along a width direction (corresponding to the tire circumferential direction) into a given width W, thereby forming a first layered sheet R3-1.

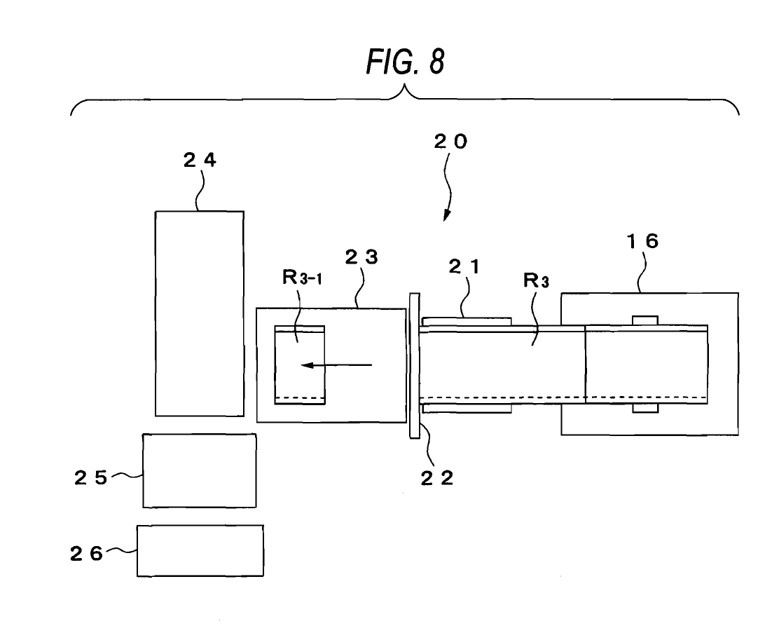

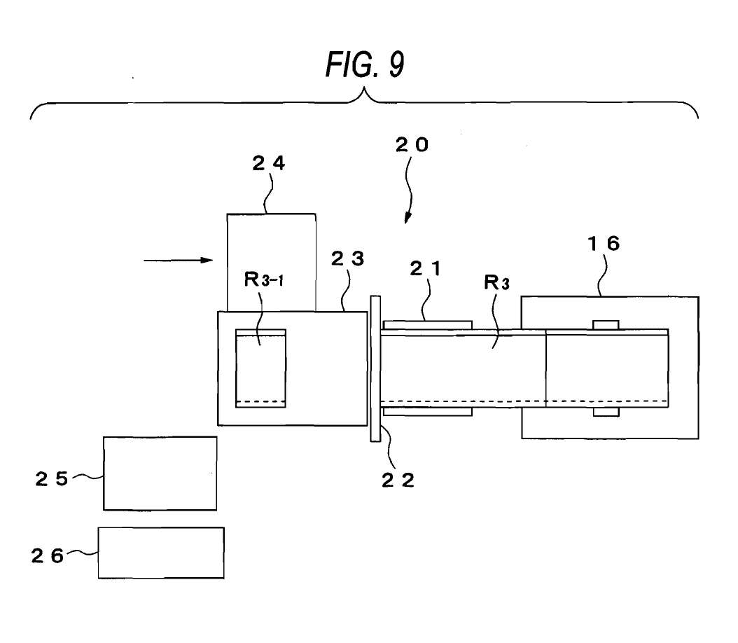

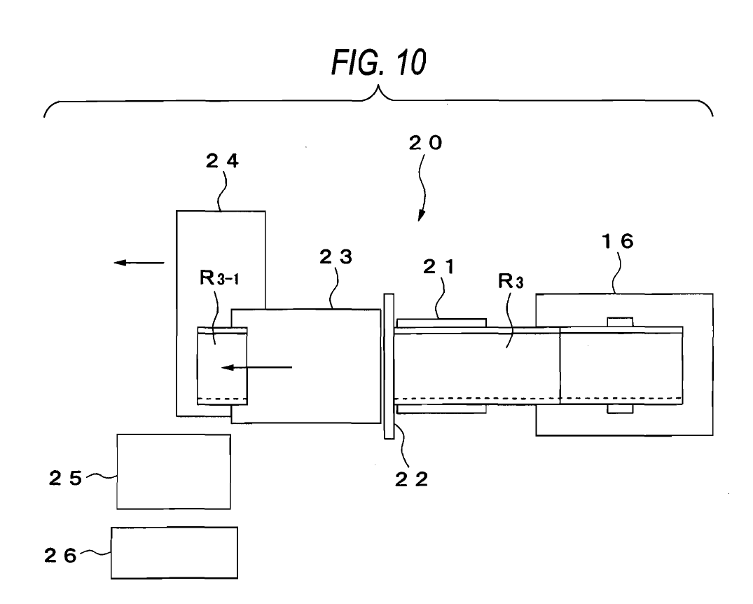

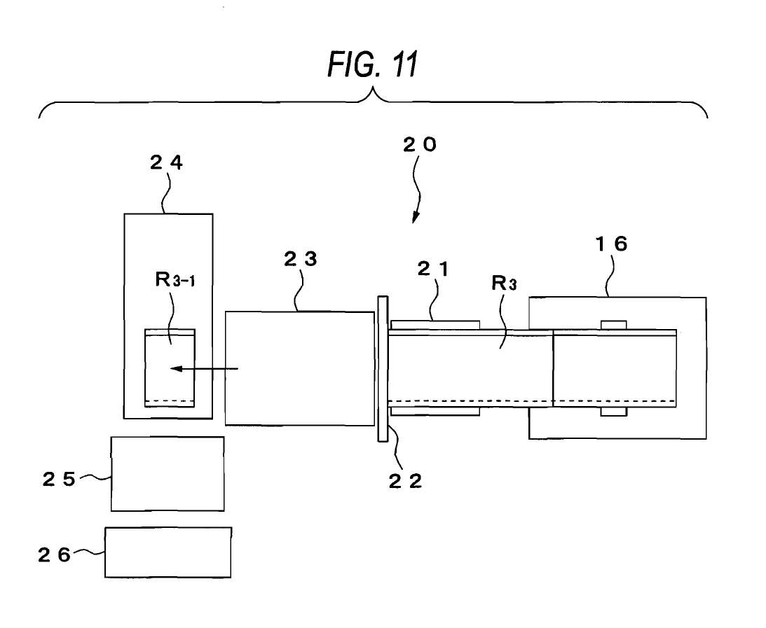

Next, as illustrated in FIG. 8, the first layered sheet R3-1 is moved onto a second conveyor 23, and as illustrated in FIG. 9, a third conveyor 24 is moved toward a second side along the tire width direction to be placed below the second conveyor 23. Subsequently, as illustrated in FIG. 10, the third conveyor 24 is moved toward the first side along the tire width direction while feeding the first layered sheet R3-1 by the second conveyor 23 in the same direction, thereby moving the first layered sheet R3-1 onto the third conveyor 24 as illustrated in FIG. 11.

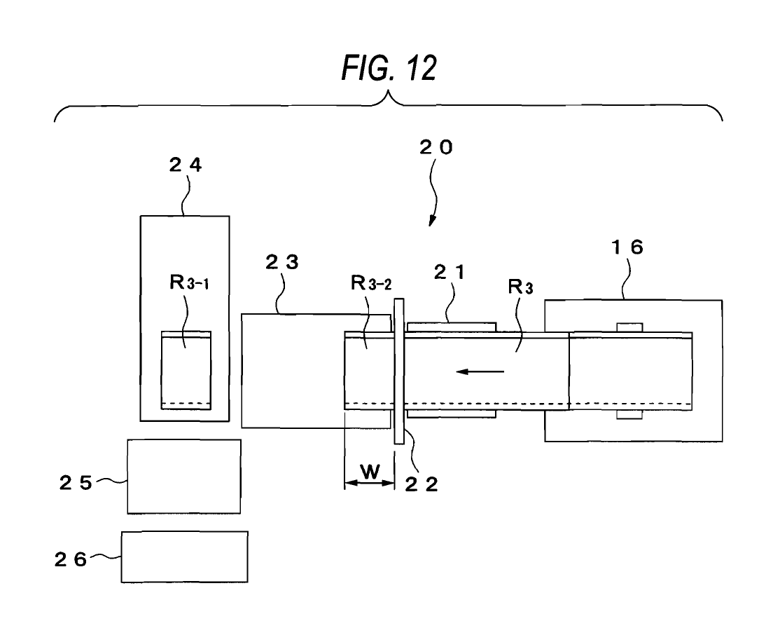

Thereafter, as illustrated in FIG. 12, another layered sheet R3 drawn out from the drum 16a of the carriage 16 is carried by the first conveyor 21 in the lengthwise direction (toward the first side along the tire width direction) and is cut with the cutter 22 along the width direction (corresponding to the tire circumferential direction) into a given width W, thereby forming a second layered sheet R3-2.

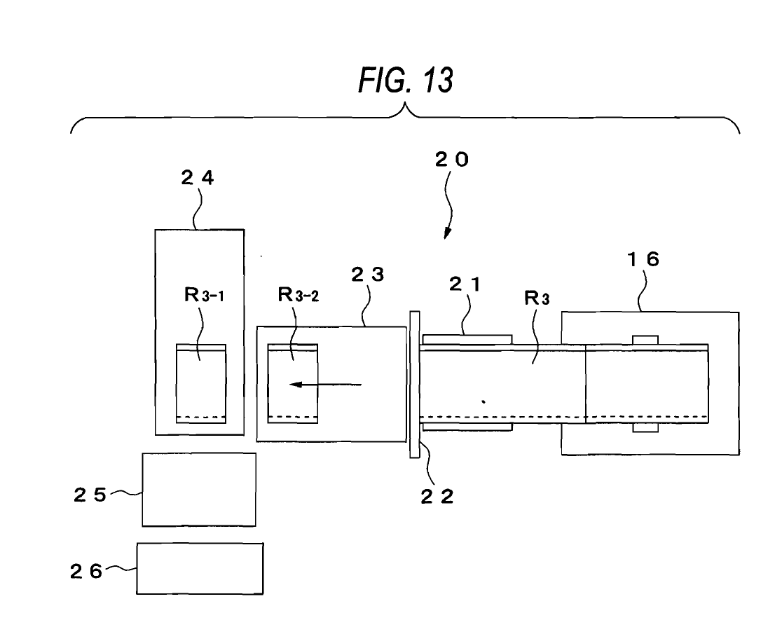

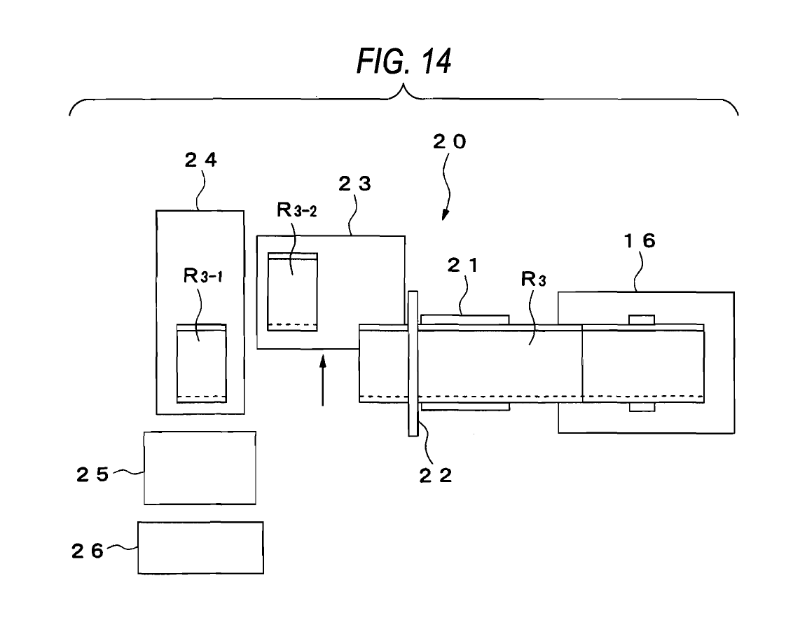

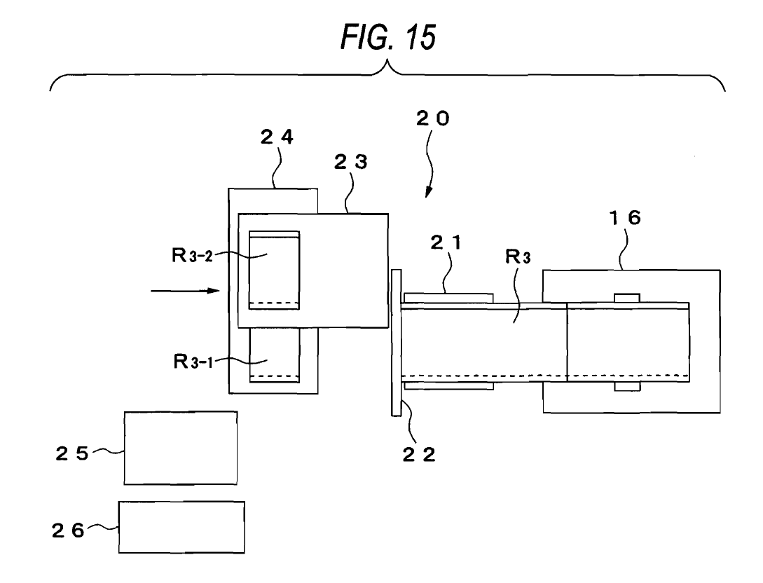

Next, the second layered sheet R3-2 is moved onto the second conveyor 23 as illustrated in FIG. 13, the second conveyor 23 is moved toward the first side along the tire circumferential direction as illustrated in FIG. 14, and the third conveyor 24 is moved toward the second side along the tire width direction to be placed below the second conveyor 23 as illustrated in FIG. 15.

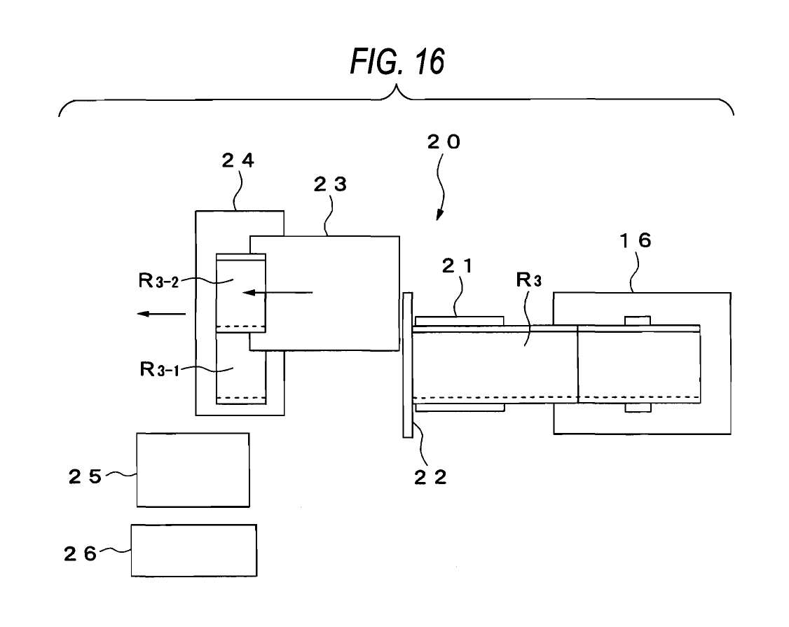

Subsequently, as illustrated in FIG. 16, the third conveyor 24 is moved toward the first side along the tire width direction while feeding the second layered sheet R3-2 by the second conveyor 23 in the same direction, thereby moving the second layered sheet R3-2 onto the third conveyor 24 so as to have an end on the first side along the tire circumferential direction of the second layered sheet R3-2 to overlap an end on the second side along the tire circumferential direction of the first layered sheet R3-1.

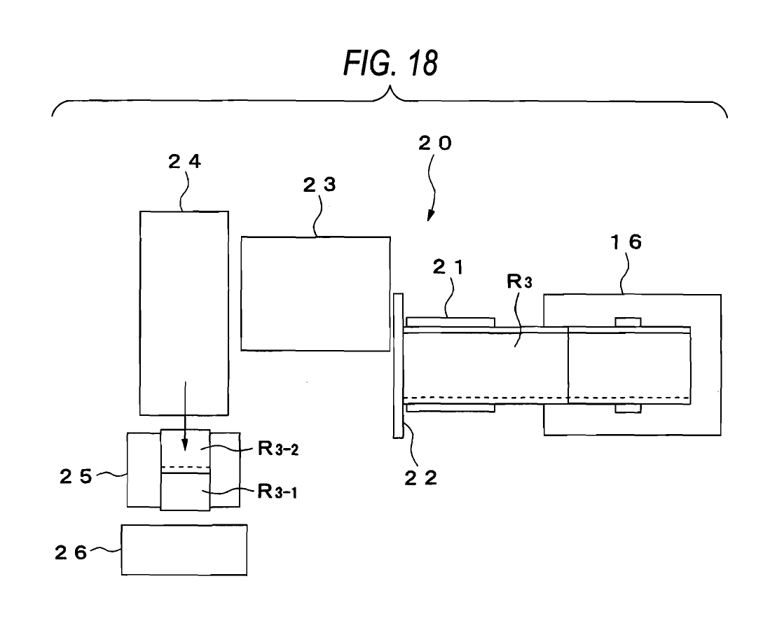

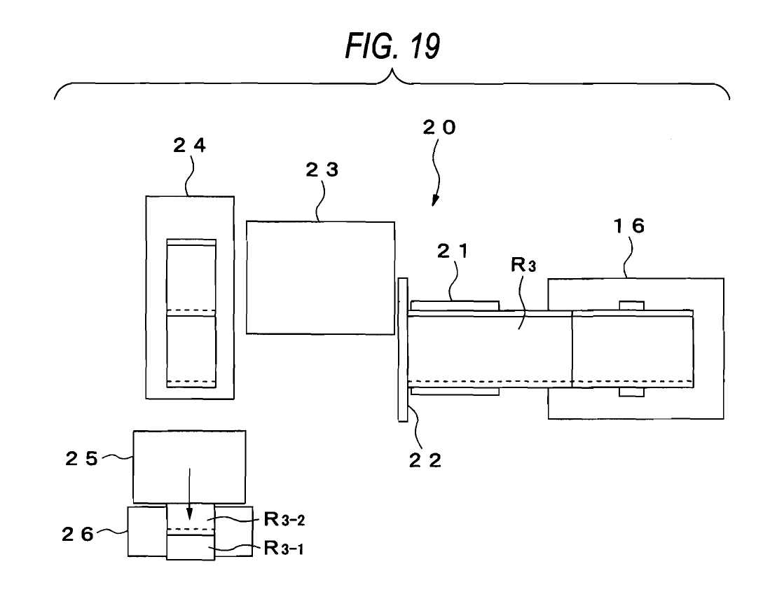

Then, the layered sheets R3-1 and R3-2 are spliced to each other. Thereafter, the layered sheets R3-1 and R3-2 are wound around a transfer drum 25 as illustrated in FIG. 18 and then are wound around a forming drum 26 from the transfer drum 25 as illustrated in FIG. 19, so as to splice one end on the first side along the tire circumferential direction of the first layered sheet R3-1 to one end on the second side along the tire circumferential direction of the second layered sheet R3-2.

In this manner, the layered sheets R3-1 and R3-2 are spliced to each other in two portions at an equal interval along the tire circumferential direction.

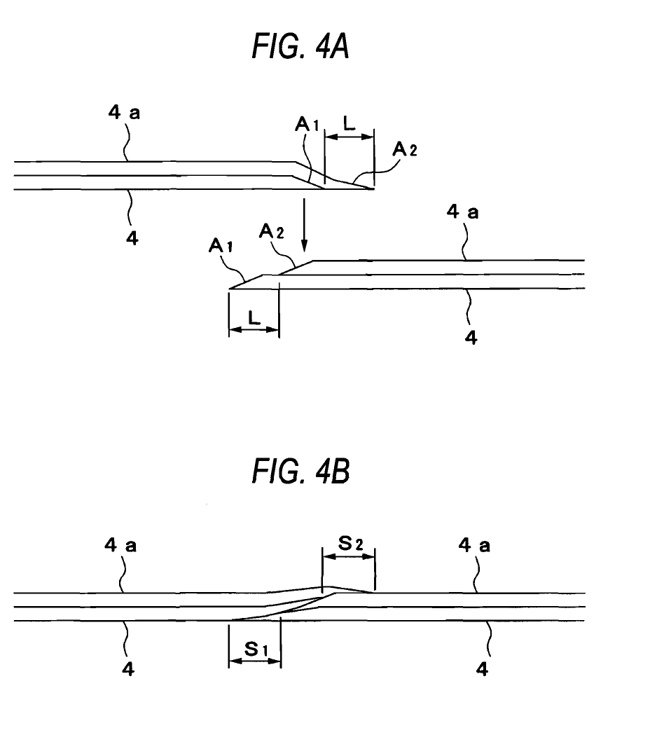

Since the inner liner 4 and the tie rubber 4a are shifted along the tire circumferential direction from each other to have their ends along the tire circumferential direction shifted from each other by the length L as illustrated in FIG. 4A, the inner liner 4 protrudes beyond the tie rubber 4a by the length L at one end along the tire circumferential direction and the tie rubber 4a protrudes beyond the inner liner 4 by the length L at the other end along the tire circumferential direction.

Therefore, when the inner liner 4 and the tie rubber 4a are layered and spliced, a splice length S1 along the tire circumferential direction between the ends of the inner liner 4 and a splice length S2 in the tire circumferential direction between the ends of the tie rubber 4a are sufficiently secured as illustrated in FIG. 4B.

Furthermore, since the inner liner 4 and the tie rubber 4a are respectively formed by cutting, in the tire width direction, the rubber sheets R1 and R2 rolled along the tire width direction and are formed with the cutting direction according with the tire circumferential direction, the elasticity along the tire width direction (corresponding to the rolling direction) is made higher through the rolling process than that along the tire circumferential direction. Therefore, the elasticity along the tire circumferential direction is lower than that along the tire width direction, and hence, the occurrence of a crack can be suppressed.

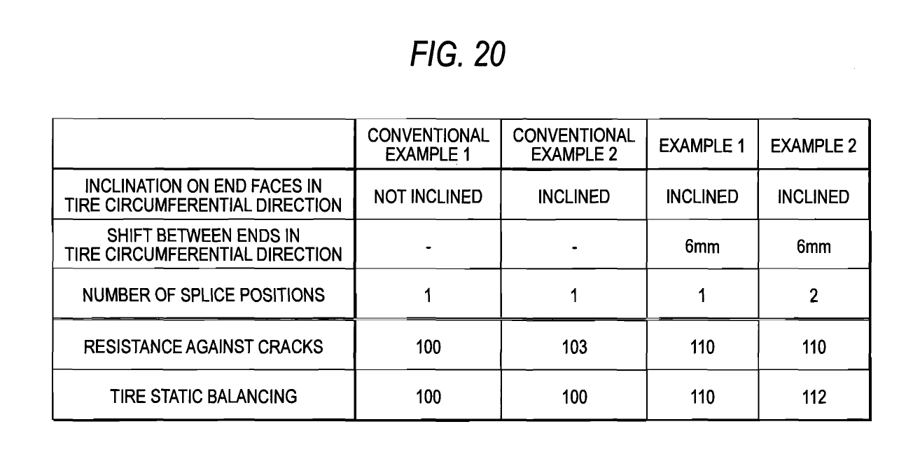

Tires according to Examples 1 and 2 and Conventional Examples 1 and 2 are tested for the occurrence of a crack and the tire static balancing, resulting in obtaining results illustrated in FIG. 20.

In Conventional Example 1, an inner liner and tie rubber are layered with their ends along the tire circumferential direction not shifted from each other, and in Conventional Example 2, an inner liner and tie rubber are layered with their ends along the tire circumferential direction not shifted from each other and cut to be inclined against the thickness direction. In both of Conventional Examples 1 and 2, one inner liner and one tie rubber are layered and spliced in one portion along the tire circumferential direction.

On the other hand, in each of Examples 1 and 2, each of an inner liner and tie rubber is formed to have inclined ends along the tire circumferential direction inclined against the tire radial direction, and they are shifted to have their ends along the tire circumferential direction shifted from each other by 6 mm. In Example 1, one inner liner and one tie rubber are layered and spliced in one portion along the tire circumferential direction, and in Example 2, two inner liners and two tie rubber are layered and spliced in two portions at an equal interval along the tire circumferential direction. Furthermore, in each of Examples 1 and 2 and Conventional Examples 1 and 2, the inner liner has a thickness of 0.7 mm and the tie rubber has a thickness of 0.7 mm. The test is performed by employing a tire size of 225/45R18 and a tire pressure of 180 kPa.

In the test for the occurrence of a crack, after running of 4800 km in a low pressure running test using an indoor drum test machine, an inverse of the depth of a crack caused in the splice portion of the inner liner is expressed with an index with that of Conventional Example 1 regarded as an index of 100, and tires are evaluated to be superior as the value of the index is larger. As a result of the test, it is found that fewer cracks are caused in the tires of Examples 1 and 2 than in the tires of Conventional Examples 1 and 2.

In the test for the tire static balancing, the tire static balancing is measured in accordance with JASOC607, and the measured static balancing is expressed with an index with that of Conventional Example 1 regarded as an index of 100, and tires are evaluated to be superior as the value of the index is larger. As a result of the test, it is found that the tires of Example 2 according to the invention are superior in the tire static balancing to those of Conventional Examples 1 and 2 and Example 1 and are improved in the uniformity.

In this manner, according to this embodiment, the inner liner 4 and the tie rubber 4a are layered to have their ends along the tire circumferential direction shifted from each other along the tire circumferential direction by the given length L and are then spliced with the ends of the inner liner 4 along the tire circumferential direction overlapping each other and with the ends of the tie rubber 4a along the tire circumferential direction overlapping each other. Therefore, the splice length S1 of the inner liner 4 along the tire circumferential direction and the splice length S2 of the tie rubber 4a along the tire circumferential direction can be sufficiently secured, so as to improve the bond strength between the ends of the inner liner 4 and between the ends of the tie rubber 4a in the splice portion. As a result, the effect to prevent the occurrence of a crack in the splice portion can be improved, so as to improve the durability of the tire.

The positions of the ends of the inner liner 4 and the ends of the tie rubber 4a are shifted along the tire circumferential direction by a length not less than 12 mm and not more than 24 mm, and therefore, the shift length L is advantageously not too small to attain a sufficient effect and can be prevented from being too large to degrade the uniformity.

Furthermore, since each of the inner liner 4 and the tie rubber 4a is formed to have the ends along the tire circumferential direction inclined against the tire radial direction, when the inclined end faces are in contact with each other, a level difference or air remain is minimally caused in the splice portion, which is very advantageous for improving the bond strength.

Each of the inner liner 4 and the tie rubber 4a is formed to have the ends along the tire circumferential direction inclined against the direction perpendicular to the tire radial direction by an inclination angle θ not less than 10 degrees and not more than 50 degrees. Therefore, the inclination angle θ is advantageously not too large to attain a sufficient effect and not so small as to cause a cutting failure in the ends along the tire circumferential direction.

Moreover, after the belt-shaped first rubber sheet R1 to be used as the inner liner 4 and the belt-shaped second rubber sheet R2 to be used as the tie rubber 4a are layered with their positions shifted along the width direction, the thus obtained layered sheet R3 is cut along the width direction to form the inner liner 4 and the tie rubber 4a, and the inner liner 4 and the tie rubber 4a are spliced after being wound around the forming drum 25 with the cutting direction according with the tire circumferential direction. Therefore, as compared with the case where, for example, the inner liner 4 and the tie rubber 4a are layered after being cut into a given length, the layered sheet R3 in which their ends along the tire circumferential direction are shifted from each other along the tire circumferential direction can be more easily formed, so as to improve the productivity.

Since the first rubber sheet R1 and the second rubber sheet R2 are formed by rolling the rubber along the tire width direction, the elasticity along the tire circumferential direction can be lower than the elasticity along the tire width direction (corresponding to the rolling direction), and therefore, the effect to prevent the occurrence of a crack in the splice portion can be further improved.

Furthermore, the rubber sheets R1 and R2 having the inclined end faces along the tire circumferential direction are respectively formed through rolling with the rollers 12a and 14a having, on their outer circumferences, the recesses 12c and 14c having the inclined faces A1 and A2 at the ends along the width direction. Therefore, the rolling of the rubber sheets and the formation of the inclined faces A1 and A2 are simultaneously performed, and hence, as compared with the case where the inclined faces are formed by cutting in a subsequent step, the productivity can be improved.

Moreover, since each of the inner liner 4 and the tie rubber 4a is divided into a plurality of portions in the tire circumferential direction and spliced in positions at equal intervals along the tire circumferential direction, the tire static balancing can be improved and the uniformity can be improved.

Although the layered sheet R3 of the inner liner 4 and the tie rubber 4a is divided along the tire circumferential direction and spliced in a plurality of positions in the tire circumferential direction in the aforementioned embodiment, it may be spliced in one position in the tire circumferential direction without dividing. Also, although each of the inner liner 4 and the tie rubber 4a has the end faces along the tire circumferential direction inclined against the tire radial direction in the aforementioned embodiment, an inner liner and tie rubber having end faces along the tire circumferential direction not inclined may be layered with their positions shifted from each other along the tire circumferential direction.

As described in the above, a splice length along the tire circumferential direction between ends of an inner liner and a splice length along the tire circumferential direction between ends of tie rubber can be sufficiently secured, and therefore, the bond strength between the ends of the inner liner and between the ends of the tie rubber in a splice portion can be improved. As a result, the effect to prevent the occurrence of a crack in the splice portion can be improved, so as to improve the durability of the tire.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiments described above. For example, some components may be deleted from the configurations described as the embodiment.

What is claimed is:

1. A pneumatic tire comprising:
a carcass;
an inner liner disposed at an inner side of the carcass in a tire radial direction; and
a tie rubber layer disposed between the carcass and the inner liner,
wherein the inner liner and the tie rubber layer are layered with the ends thereof being shifted from each other in a tire circumferential direction, and
wherein the inner liner and the tie rubber layer are spliced with the ends of the inner liner in the tire circumferential direction overlapping each other and with the ends of the tie rubber in the tire circumferential direction overlapping each other.

2. The pneumatic tire according to claim 1,
wherein the inner liner and the tie rubber layer are layered to have the ends thereof being shifted in the tire circumferential direction from each other by a length not less than 12 mm and not more than 24 mm.

3. The pneumatic tire according to claim 1,
wherein the inner liner and the tie rubber layer have end faces being formed to incline against the tire radial direction.

4. The pneumatic tire according to claim 3,
wherein the inner liner and the tie rubber layer have the end faces being formed to incline against a direction perpendicular to the tire radial direction at an inclination angle not less than 10 degrees and not more than 50 degrees.

5. A method for manufacturing a pneumatic tire comprising:
a carcass;
an inner liner disposed at an inner side of the carcass in a tire radial direction; and
a tie rubber layer disposed between the carcass and the inner liner,
wherein the method comprising:
layering the inner liner and the tie rubber layer with the ends thereof being shifted from each other in a tire circumferential direction to form a layered sheet;
winding the layered sheet around a forming drum; and
splicing the inner liner and the tie rubber layer with the ends of the inner liner in the tire circumferential direction overlapping each other and with the ends of the tie rubber in the tire circumferential direction overlapping each other.

6. The method according to claim 5,
wherein the inner liner and the tie rubber layer are layered to have the ends thereof being shifted in the tire circumferential direction from each other by a length not less than 12 mm and not more than 24 mm.

7. The method according to claim 5,
wherein the inner liner and the tie rubber layer have end faces being formed to incline against the tire radial direction.

8. The method according to claim 7,
wherein the inner liner and the tie rubber layer have the end faces being formed to incline against a direction perpendicular to the tire radial direction at an inclination angle not less than 10 degrees and not more than 50 degrees.

9. The method according to claim 5 further comprising:
forming a layered rubber sheet by layering a first rubber sheet to be used as the inner liner and a second rubber sheet to be used as the tie rubber layer with positions thereof being shifted from each other in a width direction of the layered rubber sheet; and
cutting the layered rubber sheet in the width direction to form the layered sheet of the inner liner and the tie rubber layer,
wherein the layered sheet is wound around the forming drum to match the width direction with the tire circumferential direction.

10. The method according to claim 9,
wherein the layered rubber sheet is formed by rolling the first rubber sheet and the second rubber sheet along the tire width direction.

11. The method according to claim 10,
wherein the first rubber sheet and the second rubber sheet are formed to have end faces in the tire circumferential direction being inclined, and
wherein the layered rubber sheet is formed by rolling the first rubber sheet and the second rubber sheet along the tire width direction through a roller having an outer circumference formed with a recess having inclined edges.

12. The method according to claim 5 further comprising:
splicing a plurality of divided sheets at splicing positions having a given interval to form the inner liner and the tie rubber layer.
